(19) United States
(12) Patent Application Publication
(10) Pub. No.: US 2006/0262425 A1
(43) Pub. Date: Nov. 23, 2006

(54) Liquid crystal optical element, optical device, and aperture control method

(76) Inventors: Shinya Sato, Tokyo (JP); Nobuyuki Hashimoto, Iruma-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/437,731

(22) Filed: May 22, 2006

(30) Foreign Application Priority Data
May 23, 2005 (JP) 2005-149813 (PAT.

(51) Int. Cl. G02B 9/00

(52) U.S. Cl. 359/738

(57) ABSTRACT

The present invention is intended to provide a liquid crystal optical element that is compatible with a plurality of types of recording media and that can compensate for aberration occurring during reading. The liquid crystal optical element in accordance with the present invention includes a first substrate, a second substrate, a liquid crystal provided between the first and second substrates, an electrode pattern formed on one of the first and second substrates and having an aperture control field and an aberration compensation field, and an opposite electrode, which is formed on the other one of the first and second electrodes, for applying a voltage between the electrode pattern and itself.

This application is a new U.S. patent application that claims benefit of JP2005-149813, filed on May 23, 2005, the entire content of JP2005-149813 being hereby incorporated by reference.

### FIELD OF THE INVENTION

The present invention relates to a liquid crystal optical element that performs both aperture control and aberration compensation on incident light, an optical device including the liquid crystal optical element, and an aperture control method.

### BACKGROUND OF THE INVENTION

An optical pickup device that is compatible with optical recording media which are different from one another in terms of a standard of a numerical aperture, such as CDs and DVDs because an objective lens thereof includes an electrode section and the electrode section apparently eliminates light of a certain wavelength, which falls on the perimetric part of the objective lens, through interference is known (refer to, for example, Patent Document 1).

A device that selectively changes the direction of polarization of light passing through a predetermined range in a liquid crystal filter from one direction to another, that uses a polarization beam splitter to eliminate light that has the direction of polarization thereof changed (or light having the direction of polarization thereof left unchanged), and that uses one pickup to detect information pits in either of a high-density disk and a low-density disk is known (refer to, for example, Patent Document 2).

A device that applies a voltage of a predetermined range on a liquid crystal panel so as to allow the range to act as a quarter-wave plate, that uses a polarization beam splitter to route only light, which has passed through the range, to a light receiver is known (refer to, for example, Patent Document 3). In the device, since the range allowed to act as the quarter-wave plate is selectively varied in order to change the diameter of light that passes through the liquid crystal panel, the numerical aperture of an objective lens can be substantially changed. As a result, the device is compatible with both CDs and DVDs.

A device that has wavelength selective diffraction gratings equidistantly disposed and inserted in an optical path, that allows light of a first wavelength to pass through the wavelength selective diffraction gratings, that uses the wavelength selective diffraction gratings to diffract light of a second wavelength to outside an optical axis is known (refer to, for example, Patent Document 4). In the device, the first wavelength is assigned to DVDs and the second wavelength is assigned to CDs. Consequently, the device is compatible with both DVDs and CDs while using one objective lens.

When an optical pickup device is used to read or write data from or in a recoding medium, if the recording medium is tilted due to warping of the recording medium or bending thereof, coma occurs in a substrate included in the recording medium. This is known to degrade an information signal that is produced based on a beam of light reflected from the recording medium.

When an optical pickup device reads or writes data from or in a recording medium, the distance from an objective lens to the track surface of the recording medium may not be stabilized due to irregularity in the thickness of an optically transmittable protective layer coated over the track surface. Due to the irregularity or the like, spherical aberration occurs in the substrate of the recording medium. This is known to degree a light intensity signal that is produced based on a beam of light reflected from the recording medium.

However, an optical element capable of controlling an aperture so as to be compatible with a plurality of types of recording media and capable of compensating an aberration has not yet been proposed.

Patent Document 1: JP-A-2003-344759 (FIG. 1)

Patent Document 2: JP-B-3048768 (FIG. 1)

Patent Document 3: JP-B-3476989 (FIG. 1 and FIG. 3)

Patent Document 4: JP-Y-3036314 (FIG. 3)

### SUMMARY OF THE INVENTION

An object of the present invention is to provide a liquid crystal optical element capable of performing both aperture control and aberration compensation, an optical device including the liquid crystal optical element, and an aperture control method.

A liquid crystal optical element in accordance with the present invention includes a first substrate, a second substrate, a liquid crystal provided by the first and second substrates, an electrode pattern formed on one of the first and second substrates and having an aperture control field and an aberration compensation field, an aperture control electrode disposed in the aperture control field, an aberration compensation electrode disposed in the aberration compensation field, and an opposite electrode, which is formed on the other one of the first and second substrates, for applying a voltage between the electrode pattern and itself.

In the liquid crystal optical element according to the present invention, the aperture control electrode is preferably used to perform aperture control or aberration compensation. The aperture control field is designed to be able to be used for aberration compensation.

Furthermore, in the liquid crystal optical element according to the present invention, the aperture control electrodes include a plurality of electrodes. For aperture control, the electrodes are preferably driven under substantially the same condition. For aberration compensation, the electrodes are preferably driven under different conditions. A method of driving the aperture control electrodes for the purpose of aperture control is different from a method of driving the aperture control electrodes for the purpose of aberration compensation.

Furthermore, in the liquid crystal optical element according to the present invention, preferably, the aperture control electrode changes the refractive index of the liquid crystal so that incident light passing through the aperture control field diverges. More preferably, the incident light passing through the aperture control field is directly modulated by inducing a refractive-index distribution so that the incident light passing through the aperture control field diverges. The aperture control electrode is driven in order to control induction or non-induction of a predetermined refractive-index distribution, whereby aperture control is achieved.

Furthermore, in the liquid crystal optical element according to the present invention, preferably, the aperture control electrode induces an aberration in the portion of the liquid crystal corresponding to the position of the aperture control electrode so that incident light passing through the aperture control field diverges. The aperture control electrodes preferably induce an aberration that is equivalent to approximately a quarter of the wavelength of the incident light. The aperture control electrode is driven in order to control induction or non-induction of the aberration that is equivalent to approximately a quarter of the wavelength, whereby aperture control is achieved.

Furthermore, in the liquid crystal optical element according to the present invention, preferably, the aperture control electrode induces a diffraction pattern, which brings about a phase difference, in the portion of the liquid crystal corresponding to the position of the aperture control electrode so that incident light passing through the aperture control field diverges. More preferably, the diffraction pattern induced by the aperture control electrode optically acts as a Ronchi grating. The aperture control electrode is driven in order to control induction or non-induction of a diffraction pattern that brings about a phase difference, whereby aperture control is achieved.

Furthermore, in the liquid crystal optical element according to the present invention, preferably, the aberration compensation field is defined inside the aperture control field.

Furthermore, in the liquid crystal optical element according to the present invention, preferably, a plurality of coma compensation electrodes or a plurality of spherical aberration compensation electrodes are disposed concentrically in the aberration compensation field.

An optical device in accordance with the present invention includes, a light source, a liquid crystal optical element including a first substrate, a second substrate, a liquid crystal provided between the first and second substrates, an electrode pattern formed on one of the first and second substrates and having an aperture control field and an aberration compensation field, an aperture control electrode disposed in the aperture control field, an aberration compensation electrode disposed in the aberration compensation field, an opposite electrode, which is formed on the other one of the first and second substrates, for applying a voltage between the electrode pattern and itself, and an objective lens for focusing light having passed through the liquid crystal optical element.

Moreover, an aperture control method in accordance with the present invention includes the steps of lighting a first light source, driving the aperture control electrodes by using a driving means and focusing light, which emanates from the first light source and passes through an aperture control field and an aberration compensation field in a liquid crystal optical element, on a first recording medium by using an objective lens, lighting a second light source, driving the aperture control electrode by using the driving means and focusing light, which emanates from the second light source and passes through the aberration compensation field in the liquid crystal optical element, on a second recording medium by using the objective lens.

According to the present invention, no movable part is needed, but one liquid crystal optical element is used to achieve both aperture control and aberration compensation.

Moreover, when aperture control electrodes are used to achieve aperture control and aberration compensation, aberration can be compensated for accurately.

Furthermore, the aperture control electrodes include a plurality of electrodes. When the aperture control electrodes are used to achieve aperture control and aberration compensation, if the method of driving the electrodes serving as the aperture control electrodes is changeable, aberration can be compensated for more accurately.

### BRIEF DESCRIPTION OF THE DRAWINGS

FIG. 1 shows an example of a cross section of a liquid crystal optical element in accordance with the first embodiment of the present invention;

FIG. 2 shows the relationship between a voltage applied to a liquid crystal and a refractive index;

FIG. 3A shows an example of a transparent electrode pattern;

FIG. 3B shows an example of a distribution of values of a voltage applied to the transparent electrode pattern shown in FIG. 3A;

FIG. 3C shows a refractive-index distribution;

FIG. 4A is an enlarged view of part of the transparent electrode pattern shown in FIG. 3A;

FIG. 4B shows an example of a distribution of values at which a voltage is applied to respective electrodes;

FIG. 4C shows an example of a refractive-index distribution induced by the electrodes;

FIG. 5A shows an example of a transparent electrode pattern;

FIG. 5B shows an example of another distribution of a voltage applied to the transparent electrode pattern shown in FIG. 5A;

FIG. 5C shows an example of an aberration resulting from the application of the voltage shown in FIG. 5B;

FIG. 6A shows the overview of an optical device with a second light source lit;

FIG. 6B shows the overview of the optical device with a first light source lit;

FIG. 7A shows another example of a transparent electrode pattern;

FIG. 7B shows an example of a distribution of values of a voltage applied to the transparent electrode pattern shown in FIG. 7A;

FIG. 7C shows an example of an aberration resulting from the application of the voltage shown in FIG. 7B;

FIG. 8 shows an example of a cross section of a liquid crystal optical element in accordance with the second embodiment of the present invention;

FIG. 9 shows the relationship between a voltage applied to a liquid crystal and a phase;

FIG. 10A shows another example of a transparent electrode pattern;

FIG. 10B shows an example of a distribution of values of a voltage applied to the transparent electrode pattern shown in FIG. 10A;

FIG. 10C shows an example of an aberration resulting from the application of the voltage shown in FIG. 10B;

FIG. 11A shows still another example of a transparent electrode pattern;

FIG. 11B shows an example of a distribution of values of a voltage applied to the transparent electrode pattern shown in FIG. 11A;

FIG. 11C shows an example of an aberration resulting from the application of the voltage shown in FIG. 11B;

FIG. 12A shows the overview of an optical device with a second light source lit;

FIG. 12B shows the overview of the optical device with a first light source lit;

FIG. 13 shows an example of a cross section of a liquid crystal optical element in accordance with the third embodiment of the present invention;

FIG. 14 shows the relationship between a voltage applied to a liquid crystal and a phase difference;

FIG. 15A shows still another example of a transparent electrode pattern;

FIG. 15B shows an example of a distribution of values of a voltage applied to the transparent electrode pattern shown in FIG. 15A;

FIG. 15C shows an example of an aberration resulting from the application of the voltage shown in FIG. 15B;

FIG. 16A is an enlarged view of part of the transparent electrode pattern shown in FIG. 15A;

FIG. 16B shows an example of a distribution of values at which a voltage is applied to respective electrodes;

FIG. 16C shows an example of a refractive-index distribution induced by the electrodes;

FIG. 17A shows still another example of a transparent electrode pattern;

FIG. 17B shows an example of a distribution of values of a voltage applied to the transparent electrode pattern shown in FIG. 17A;

FIG. 17C shows an example of an aberration resulting from the application of the voltage shown in FIG. 17B;

FIG. 18A shows the overview of an optical device with a second light source lit; and

FIG. 18B shows the overview of the optical device with a first light source lit.

### DESCRIPTION OF THE PREFERRED EMBODIMENTS

Referring to the drawings, a liquid crystal optical element, an optical device, and an aperture control method in accordance with the present invention will be described below. It should be noted that the present invention is not limited to embodiments shown in the drawings or described below.

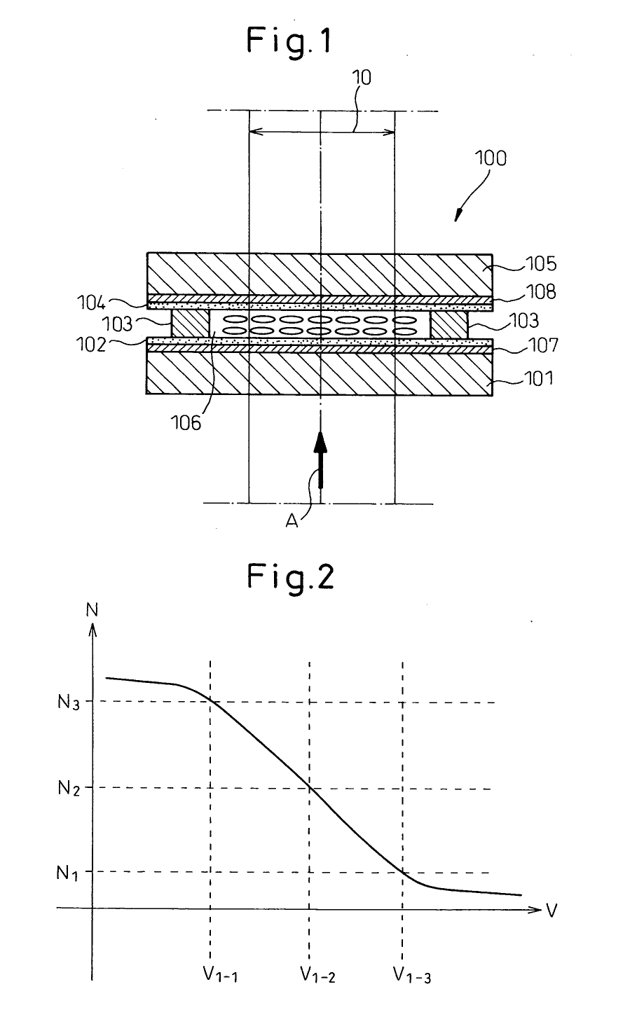

FIG. 1 shows a cross section of a liquid crystal optical element 100 in accordance with the first embodiment of the present invention.

The liquid crystal optical element 100 in accordance with the first embodiment includes an aperture control field and an aberration compensation field. A refractive-index distribution is induced in the aperture control field, thus allowing light to diverge. Eventually, an aperture is limited.

Referring to FIG. 1, a direction indicated by an arrow A is a direction in which light travels to fall on the liquid crystal optical element 100. An incidence-side transparent substrate 101 has a transparent electrode 107, which includes a transparent electrode pattern 200 that is, as described later, used to compensate for a refractive index, and an alignment layer 102 formed thereon. Moreover, an opposite transparent substrate 105 has a transparent opposite electrode 108 and an alignment layer 104 formed thereon. A liquid crystal 106 is sealed in a space defined by the two transparent substrates 101 and 105 and sealing members 103 so that the liquid crystal has a thickness of approximately 10 μm. The elements shown in FIG. 1 are exaggerated for the sake of description. The ratio of thicknesses in FIG. 1 is different from the actual one.

The two transparent substrates 101 and 105 are made of a glass material. The sealing members 103 are made of a resin. In the present embodiment, the liquid crystal 106 sandwiched between the two transparent substrates 101 and 105 is a nematic liquid crystal exhibiting homogeneous alignment. Alternatively, a liquid crystal exhibiting homeotropic alignment may be adopted.

FIG. 2 shows the relationship between a voltage applied to the liquid crystal 106 employed in the present embodiment and an effective refractive index.

As shown in FIG. 2, the liquid crystal 106 exhibits a nonlinear characteristic that the effective refractive index gradually decreases along with a rise in the applied voltage. However, the effective refractive index nearly linearly changes relative to some range of applied voltage values such as the range thereof from a value V₁₋₁ to a value V₁₋₃. In the present embodiment, the range of applied voltage values is used to control the refractive index.

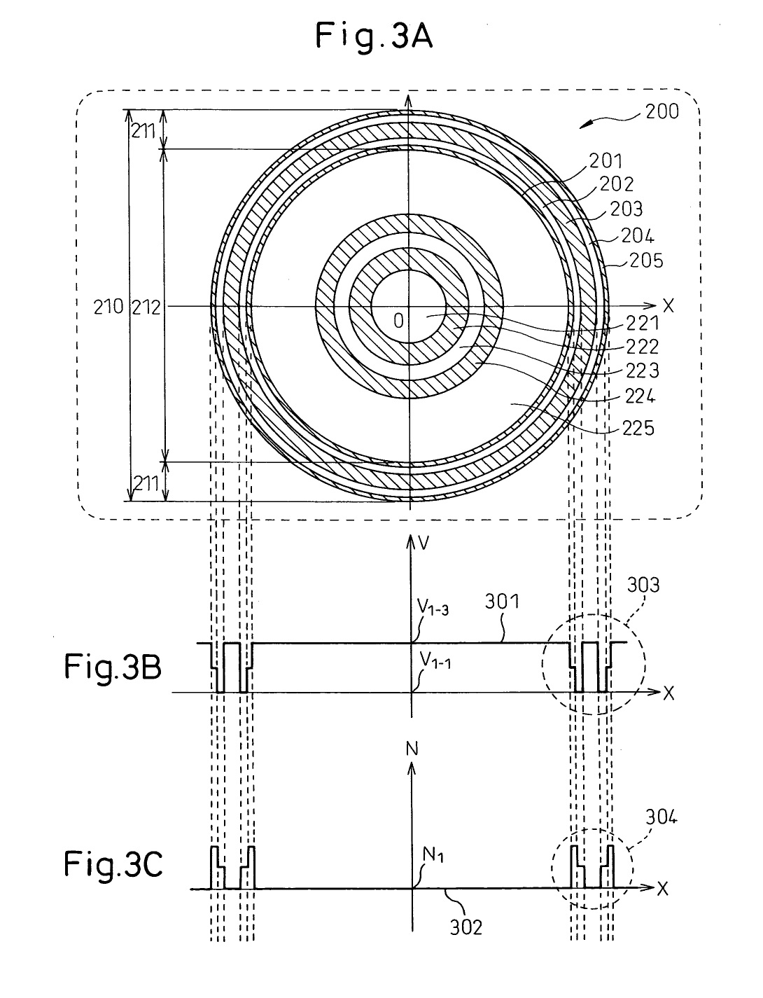

FIG. 3A shows an example of the transparent electrode pattern 200 having the aberration compensation field and aperture control field which can be employed in the liquid crystal optical element 100 shown in FIG. 1.

The electrode pattern 200 includes, as shown in FIG. 3A, the aperture control field 211 defined inside the perimeter of the electrode pattern 200 having a diameter 210, and the aberration compensation field 212 defined inside the aperture control field 211. Moreover, aperture control electrodes 201 to 205 are disposed concentrically in the aperture control field 211. Furthermore, spherical aberration compensation electrodes 221 to 225 are disposed concentrically in the aberration compensation field 212. A microscopic space is interposed between adjoining ones of the aperture control electrodes 201 to 205 and adjoining ones of the spherical aberration compensation electrodes 221 to 225 for the purpose of isolation.

Examples of the radii of the respective aperture control electrodes 201 to 205 are provided as R₁=0.80, R₂=0.83, R₃=0.95, R₄=0.98, and R₅=1.00 (which all except R₅ signify a distance to a middle point of the space between adjoining electrodes). These values of the radii are calculated in relation to the outermost radius R₅ of electrode 205 defined as 1.00.

FIG. 3B shows an example of a distribution of values of a voltage to be applied in a case where the electrode pattern is driven so that incident light passing through the aperture control field diverges. Moreover, FIG. 3C shows an example of a refractive-index distribution induced in a case where the voltage whose distribution is shown in FIG. 3B is applied to the transparent electrode pattern 200. When a potential difference is produced between the transparent electrode pattern 200 and opposite electrode 108 in order to induce the refractive-index distribution 302 shown in FIG. 3C, incident light passing through the aperture control field 211 is allowed to diverge, but is substantially not focused by the objective lens.

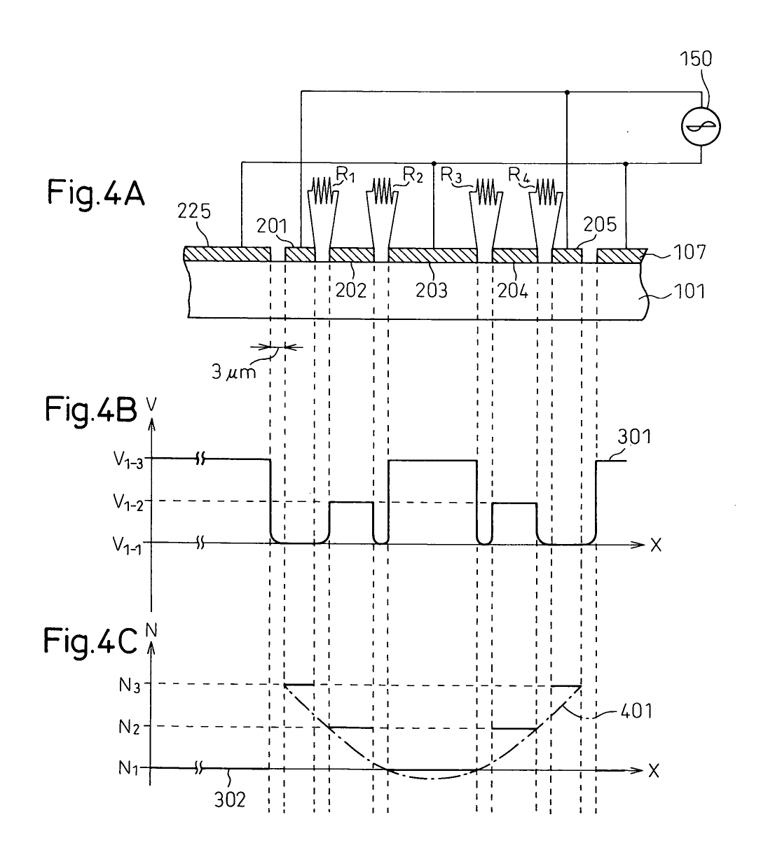

FIG. 4 shows a distribution of values of a voltage to be applied to the aperture control field and a refractive-index distribution.

FIG. 4A is an enlarged view of part of the aperture control field 211 shown in FIG. 3A. Herein, the microscopic space between adjoining electrodes is set to 3 μm (which is shown in enlargement for the sake of convenience). Moreover, a resistor R₁ is interposed between the electrodes 201 and 202. A resistor R₂ is interposed between the electrodes 202 and 203. A resistor R₃ is interposed between the electrodes 203 and 204. A resistor R₄ is interposed between the electrodes 204 and 205. A drive control circuit 150 is used to apply a predetermined ac voltage to an electrode between the electrodes 203 and 201 or between the electrodes 203 and 205.

FIG. 4B shows in enlargement part 303 of the applied-voltage distribution shown in FIG. 3B. FIG. 4B shows an effective voltage with respect to a reference voltage V₁₋₁ (a voltage to be applied to each of the electrodes 201 and 205 and set to 0 V). As shown in FIG. 4B, the voltage V₁₋₁ is applied to each of the electrodes 201 and 205. A voltage V₁₋₂ is applied to each of the electrodes 202 and 204. A voltage V₁₋₃ is applied to each of the electrode 203 and the aberration compensation electrodes 221 to 225.

The liquid crystal to be employed in the liquid crystal optical element generally responds to an effective value of an applied voltage. Moreover, when a direct voltage component is kept applied to the liquid crystal for a prolonged period of time, image persistence, image decomposition, or other drawbacks ensue. Therefore, an alternating voltage is applied to the transparent electrodes included in the liquid crystal optical element, but a direct voltage component is not applied, whereby the liquid crystal is driven. Moreover, the reference voltage of 0 V to be applied to the liquid crystal optical element is, strictly speaking, a voltage to be applied to the liquid crystal layer, and may be determined arbitrarily. In general, the state of an applied voltage that is 0 V is regarded as a reference. Any other voltage value (for example, 3 V) may be regarded as the reference voltage.

FIG. 4C shows in enlargement part 304 of the refractive-index distribution shown in FIG. 3C. FIG. 4C shows a refractive index N exhibited by the liquid crystal 106 interposed between the electrodes and the transparent opposite electrode 108. Due to the relationship of a refractive index to an applied voltage shown in FIG. 2, the electrode 203 and the aberration compensation electrodes 301 to 305 induce a refractive index N₁ (for example, 0). The electrodes 202 and 204 induce a refractive index N₂, and the electrodes 201 and 205 induce a refractive index N₃.

As mentioned above, the refractive-index distribution 302 induced by the electrodes 201 to 205 disposed in the aperture control field 211 signifies that, as shown in FIG. 4C, a low refractive index is induced in the center of the aperture control field 211 and a high refractive index is induced at both ends thereof. This means that the aperture control field 211 acts as an annular concave lens (gradient index lens 401). Consequently, incident light passing through the aperture control field 211 is, as signified by the refractive-index distribution 302, allowed to diverge outside an optical path in the same manner as the light passing through a concave lens. Moreover, since the refractive index N, (for example, 0) is induced in the aberration compensation field 212, the liquid crystal optical element 100 does not act at all on light passing through the aberration compensation field 212.

As mentioned above, when the transparent electrode pattern 200 shown in FIG. 3A is used, if the refractive-index distribution 302 shown in FIG. 3C is induced, light passing through the aperture control field 211 is allowed to diverge. Specifically, when light emanating from the light source falls on the liquid crystal optical element 100 in which the refractive-index distribution 302 is induced, light passing through the aperture control field 211 diverges and only light incident on the aberration compensation field 212 passes through the liquid crystal optical element 100 as it is.

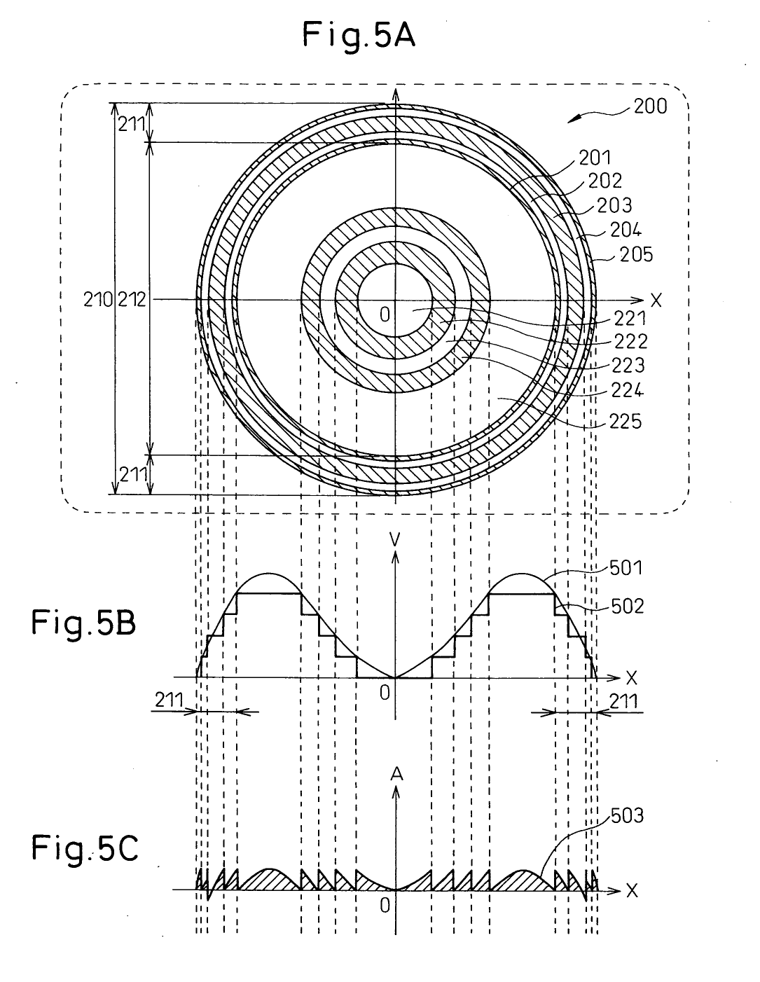

FIG. 5A shows the same transparent electrode pattern 200 as the one shown in FIG. 3A. FIG. 5B shows an example of values of a voltage applied to the transparent electrode pattern 200 in order to compensate a spherical aberration. FIG. 5C shows an example of values of a compensated aberration (A).

A curve 501 shown in FIG. 5B is an example of a profile representing the values of a spherical aberration, which is attributable to the fact that the distance from the objective lens to the track surface of a recording medium is not stabilized because of the irregularity in the thickness of an optically transmittable protective layer coated over the track surface, by converting positions in an entrance pupil formed by the objective lens. When a voltage whose distribution is indicated by a graph 502 in FIG. 5B is applied to the electrodes 201 to 205 disposed in the aperture control field 211 and the electrodes 221 to 225 disposed in the aberration compensation field 212, a potential difference occurs between the electrode pattern 200 and the transparent opposite electrode 108. The orientation of the liquid crystal 106 interposed between the opposite electrode and electrode pattern changes proportionally to the potential difference. Consequently, a light beam passing through the liquid crystal has the phases of light waves thereof delayed proportionally to the potential difference. Therefore, spherical aberration 501 is, like a residual aberration 503 resulting from aberration compensation and being shown in FIG. 5C, restricted by the phase delay proportional to the potential difference.

When the voltage 502 whose distribution is shown in FIG. 5B is applied to the transparent electrode pattern 200, the voltage whose distribution is shown in FIG. 3B or FIG. 4B is not applied to the electrodes 201 to 205 disposed in the aperture control field 211. The refractive-index distribution shown in FIG. 3C or FIG. 4C is not induced. Light passing through the aperture control field 211 is not allowed to diverge.

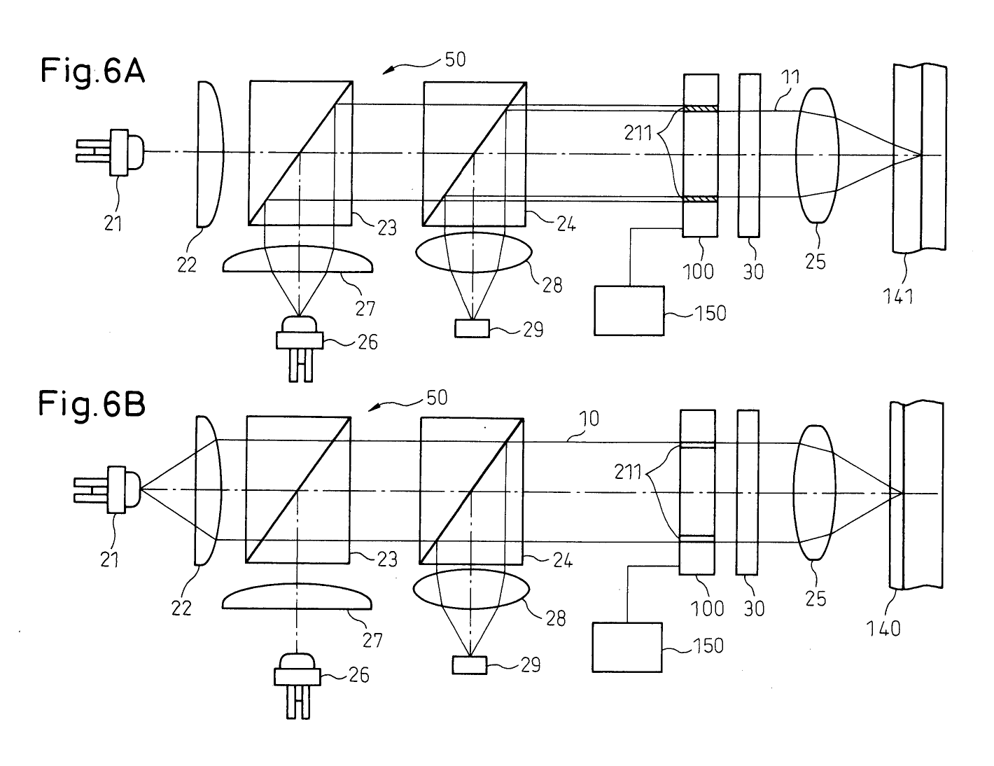

FIG. 6 shows an example of the outline configuration of an optical device 50 employing the liquid crystal optical element 100 that has the transparent electrode pattern 200.

As shown in FIG. 6, the optical device 50 includes a first light source 21, a first collimator lens 22, a second light source 26, a second collimator lens 27, a half mirror 23, a polarization beam splitter 24, a liquid crystal optical element 100 including an aperture control field 211 and an aberration compensation field 212, a drive control circuit 150 for the liquid crystal optical element 100, a quarter-wave plate 30, an objective lens 25, a condenser lens 28, and light receiver 29.

The diameter of the transparent electrode pattern 200 defined by the perimeter of the aperture control field 211 is coincident with an effective diameter 10 (φ=3 mm) attained when the first light source 21 is employed. The diameter of the aberration compensation field 212 is coincident with an effective diameter 11 (φ=2.35 mm) attained when the second light source 26 is employed.

FIG. 6A shows a case where the second light source 26 is lit and a second recording medium 141 such as a CD is employed.

In this case, the drive control circuit 150 extends control so that the voltage 301 whose distribution is shown in FIG. 3B is applied to the transparent electrode pattern 200 of the light crystal optical element 100. Consequently, the liquid crystal optical element 100 acts as an annular concave lens on incident light passing through the aperture control field 211. The light passing through the aperture control field 211 is allowed to diverge but is not focused on the track surface of the second recording medium 141 by the objective lens 25. The liquid crystal optical element 100 does not affect light passing through the portion of the transparent electrode pattern having the effective diameter 11. Moreover, aberration compensation is not performed by the aberration compensation field 212 of the liquid crystal optical element 100.

A second light beam (780 nm) emanating from the second light source 26 is converted into nearly parallel-ray light by the second collimator lens 27, and has the path thereof changed by the half mirror 23. The second light beam then passes through the polarization beam splitter 24 and liquid crystal optical element 100 and falls on the quarter-wave plate 30. As mentioned above, light passing through the aperture control field 211 of the liquid crystal optical element 100 is allowed to diverge but is not substantially focused by the objective lens 25. A light beam whose diameter corresponds to the effective diameter 11 and which has passed through the quarter-wave plate 30 is focused on the track surface of the second recording medium 141 by the objective lens 25 (in this case, a numerical aperture NA is 0.51).

The light beam reflected from the second recording medium 141 passes through each of the objective lens 25, quarter-wave plate 30, and liquid crystal optical element 100, and has the path thereof changed by the polarization beam splitter 24. Eventually, the light beam is converged on the light receiver 29 by the condenser lens 28. When the light beam is reflected from the second recording medium 141, the amplitude thereof is modulated by information (pits) stored in the track surface of the second recording medium 141. The light receiver 29 transmits a light intensity signal proportional to the modulated amplitude of the received light beam. The information recorded in the second recording medium is acquired from the light intensity signal (radiofrequency signal).

FIG. 6B shows a case where the first light source 21 is lit and a first recording medium 140 such as a DVD is employed.

In this case, the drive control circuit 150 extends control so that the voltage whose distribution is shown in FIG. 5B is applied to the transparent electrode pattern 200 of the liquid crystal optical element 100. Since the liquid crystal optical element 100 does not allow incident light, which passes through the aperture control field 211, to diverge, the objective lens 25 can utilize all of light passing through the portion of the liquid crystal optical element having the effective diameter 10.

Furthermore, the liquid crystal optical element 100 uses the aperture control field 211 and aberration compensation field 212 to perform spherical aberration compensation. Consequently, spherical aberration derived from inconsistency of the center of the diameter of a light beam with the center of the objective lens caused by erroneous tracking or attachment can be compensated for appropriately (see FIG. 5C).

A first light beam (650 nm) emanating from the first light source 21 is converted into nearly parallel-ray light by the first collimator lens 22. After the first light beam passes through each of the half mirror 23, polarization beam splitter 24, and liquid crystal optical element 100, the first light beam falls on the quarter-wave plate 30. The light beam whose diameter corresponds to the effective diameter 10 and which has passed through the quarter-wave plate 30 is focused on the track surface of the first recording medium 140 by the objective lens 25 (in this case, a numerical aperture NA is 0.65).

The light beam reflected from the first recording medium 140 passes through each of the objective lens 25, quarter-wave plate 30, and liquid crystal optical element 100, and has the path thereof changed by the polarization beam splitter 24. Finally, the light beam is converged on the light receiver 29 by the condenser lens 28. When the light beam is reflected from the first recording medium 140, the amplitude thereof is modulated by information (pits) recorded in the track surface of the first recording medium 140. The light receiver 29 transmits a light intensity signal proportional to the modulated amplitude of the received light beam. The information recorded in the first recording medium is acquired from the light intensity signal (radiofrequency signal).

As mentioned above, the voltage 301 whose distribution is shown in FIG. 3B is applied to the transparent electrode pattern 200 of the liquid crystal optical element 100 included in the optical device 50. This allows light, which passes through the aperture control field 211, to diverge and permits utilization of only light passing through the aberration compensation field 212. Moreover, when the voltage 502 shown in FIG. 5B is applied to the transparent electrode pattern 200, light passing through the aperture control field 211 and aberration compensation field 212 can be utilized, and the light passing through the aperture control field 211 and aberration compensation field 212 can be compensated for aberration. In other words, one liquid crystal optical element can achieve both aperture control and aberration compensation so as to be compatible with a plurality of types of recording media (DVD and CD).

In the present embodiment, as described in conjunction with FIG. 6, a DVD and CD are cited for instance. However, the DVD and CD are mere examples. When the aperture control field 211 is optimized, the present embodiment can support any other format requiring a different numerical aperture. For example, when both the Blu-Ray format and DVD format are employed, a numerical aperture stipulated for the Blu-Ray format is 0.85, while a numerical aperture stipulated for the DVD format is 0.65. Therefore, the aperture control field 211 is defined so that the ratio of apertures through which light falls on a Blu-Ray disk and a DVD respectively via the objective lens designed for the Blu-Ray format (ratio of effective diameters) will be 0.85 to 0.65. Light incident on the aperture control field 211 is allowed to diverge, whereby the aperture for a light beam is limited. Thus, the numerical aperture of the objective lens designed for the Blu-Ray format can be converted into the one to be exhibited by an objective lens designed for the DVD format. Furthermore, the liquid crystal optical element 100 has one aperture control field 211. Alternatively, the liquid crystal optical element 100 may have a plurality of kinds of aperture control fields. In this case, one objective lens is used to support three or more types of different recording media.

Moreover, the liquid crystal optical element 100 in accordance with the present embodiment includes the transparent electrode pattern 200 whose aperture control field 211 acts as an annular concave lens. However, as long as light passing through the aperture control field 211 diverges but is substantially not focused by the objective lens 25, the transparent electrode pattern 200 does not necessarily have to be designed to have the capability of a concave lens. For example, the transparent electrode pattern 200 included in the liquid crystal optical element 100 may be designed so that the aperture control field 211 thereof has the capability of an annular convex lens. Moreover, the transparent electrode pattern included in the liquid crystal optical element 100 may be designed so that the aperture control field 211 includes a plurality of electrodes which are disposed with an unequal or random space between adjoining ones and which have the same or different widths. When an appropriate voltage is applied to the transparent electrode pattern 200 that includes a plurality of electrodes which are disposed with an unequal or random space between adjoining ones and which have the same or different widths, light passing through the aperture control field 211 diverges but substantially is not focused by the objective lens. Incidentally, the unequal space signifies that a pitch between adjoining ones of electrodes is not equal. For example, a transparent electrode pattern having a plurality of electrodes, which have the same width, disposed equidistantly in the aperture control field 211 of the liquid crystal optical element 100 should not be designed for the unequal space.

What is significant for the aperture control field 211 included in the present embodiment is that incident light passing through the aperture control field 211 diverges but is not focused by the objective lens 25. Consequently, the refractive-index distribution 302 shown in FIG. 3C need not be accurately induced all the time. The relationship between an applied voltage and a refractive index shown in FIG. 2 varies, depending on ambient temperature. Even if the refractive-index distribution 302 changes accordingly, the incident light passing through the aperture control field 211 still diverges. In other words, the liquid crystal optical element 100 can achieve aperture control irrespective of the ambient temperature.

Furthermore, in the present embodiment, the liquid crystal optical element 100 is designed so that aperture control is achieved for light emanating from the first light source (650 nm) and light emanating from the second light source (780 nm). Although the relationship between an applied voltage and a refractive index shown in FIG. 2 varies, depending on the wavelength of incident light, even if the refractive-index distribution 302 changes accordingly, incident light passing through the aperture control field 211 still diverges. In other words, the liquid crystal optical element 100 can achieve aperture control irrespective of the wavelength of a light beam to be employed. Consequently, not only two kinds of light beams, but also three or more kinds of different light beams may be utilized.

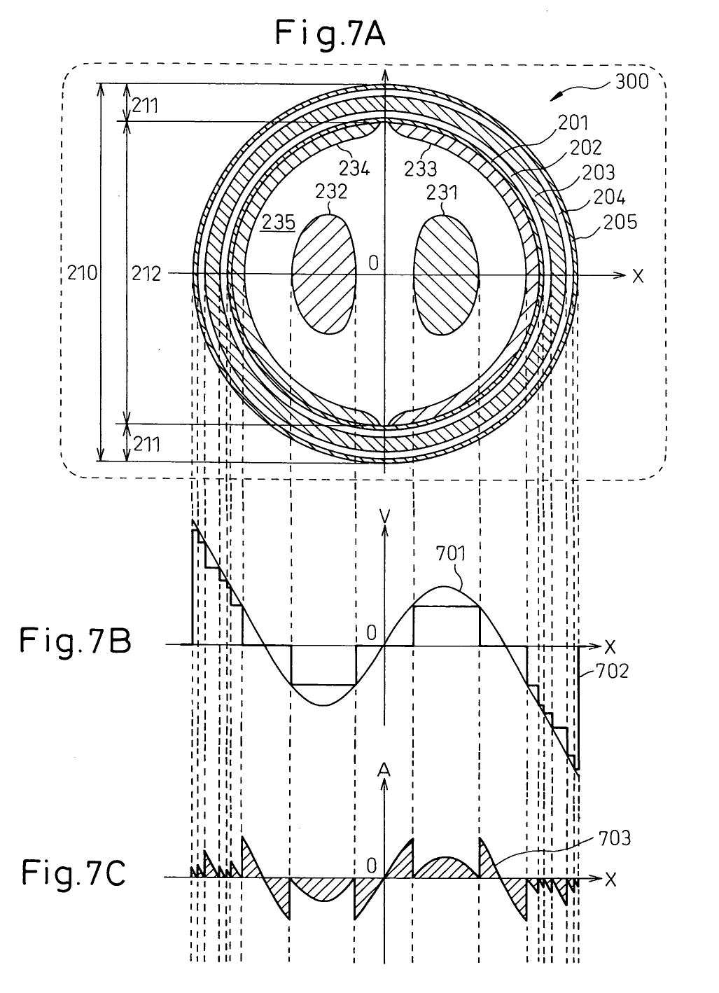

In the present embodiment, when the aperture control field 211 is controlled in order to allow light, which passes through the aperture control field 211, to diverge, the electrodes disposed in the aberration compensation field 212 are, as shown in FIG. 3B, not used to achieve aberration compensation. However, in the case shown in FIG. 6A, for example, assuming that spherical aberration or coma needs to be compensated for greatly, when the aperture control field 211 allows light to diverge, the aberration compensation field 212 may, as shown in FIG. 5B or FIG. 7B, be used to achieve the aberration compensation at the same time.

In the present embodiment, the transparent electrode pattern 200 has been described to have, as shown in FIG. 3A and FIG. 5A, the spherical aberration compensation electrodes disposed in the aberration compensation field 212. Coma may be compensated for instead of spherical aberration. Another transparent electrode pattern that has an aperture control field and an aberration compensation field for coma and that can be employed in the present embodiment will be described below.

FIG. 7A shows a transparent electrode pattern 300 having an aperture control field and an aberration compensation field for coma. FIG. 7B shows an example of a distribution of values of a voltage applied to the transparent electrode pattern 300. FIG. 7C shows an example of a compensated-for aberration (A).

The transparent electrode pattern 300 shown in FIG. 7A is formed on the transparent electrode 107 included in the liquid crystal optical element 100 shown in FIG. 1. The liquid crystal optical element 100 including the transparent electrode pattern 300 can be adapted to the optical device 50 shown in FIG. 6A and FIG. 6B.

The transparent electrode pattern 300 has, as shown in FIG. 7A, electrodes 201 to 205 disposed in the aperture control field 211 shown in FIG. 3A, and has electrodes 231 to 235 that are used to compensate for coma. Moreover, the electrodes 231 to 235 are, similarly to those included in the transparent electrode pattern 200 shown in FIG. 3A, disposed with a microscopic space between adjoining ones thereof for isolation.

A curve 701 shown in FIG. 7B is an example of a profile representing the values of coma, which is attributable to the fact that the optical axis of a light beam focused by the objective lens 25 becomes oblique with respect to the track surface of the recording medium 140, that are calculated by converting positions in an entrance pupil formed by an objective lens. When a voltage 702 whose distribution is shown in FIG. 7B is applied to each of the electrodes 201 to 205 and the electrodes 231 to 235, a potential difference occurs between the transparent electrode pattern 300 and the transparent opposite electrode 108. Consequently, the orientation of the liquid crystal 106 interposed between the transparent electrode pattern 300 and the transparent opposite electrode 108 changes proportionally to the potential difference. A light beam passing through the liquid crystal is caused to have the phases of light waves thereof delayed proportionally to the potential difference. Consequently, coma 701 is, like residual aberration 703 resulting from aberration compensation as shown in FIG. 7C, restricted by a phase delay proportional to the potential difference.

When the aperture control field 211 in the transparent electrode pattern 300 is used to perform aperture control, the voltage distribution 301 shown in FIG. 3 is induced in the transparent electrode pattern 300. Consequently, the refractive-index distribution 302 shown in FIG. 3C is observed. Consequently, light passing through the aperture control field 211 is allowed to diverge, but is not focused by the objective lens 25.

As mentioned above, in the transparent electrode pattern 300, the aperture control field 211 in the transparent electrode pattern 300 is used to control an aperture for a light beam. Furthermore, the aperture control field 211 and aberration compensation field 212 are used to compensate for coma.

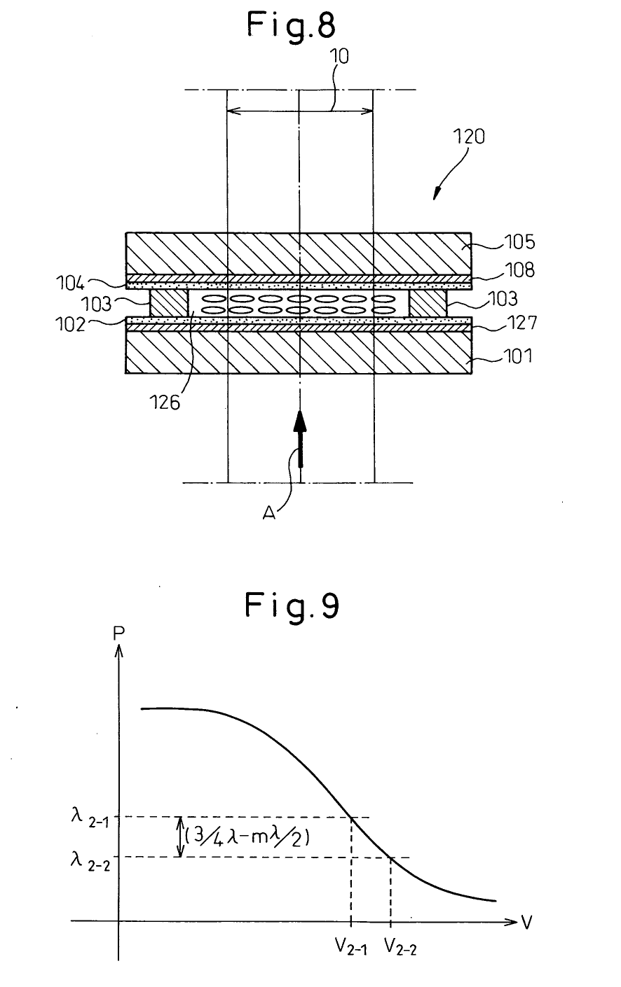

FIG. 8 shows a cross section of a liquid crystal optical element 120 in accordance with the second embodiment of the present invention.

The liquid crystal optical element 120 in accordance with the second embodiment includes an aperture control field and an aberration compensation field and allows the aperture control field to induce a maximum aberration for the purpose of limiting an aperture.

In FIG. 8, a direction indicated by an arrow A is a direction in which light travels so as to fall on the liquid crystal optical element 120. In FIG. 8, the same reference numerals are assigned to components identical to those shown in FIG. 1. A marked difference between the liquid crystal optical element 100 shown in FIG. 1 and the liquid crystal optical element 120 shown in FIG. 8 is that the liquid crystal optical element 120 shown in FIG. 8 includes a transparent electrode 127 having a transparent electrode pattern 400 that is used to control optical rotatory power.

FIG. 9 shows a graph indicating the relationship between a voltage (V) to be applied to a liquid crystal 126 employed in the present embodiment and a phase (P).

As shown in FIG. 9, the liquid crystal 126 exhibits a nonlinear characteristic that the phase of light decreases along with a rise in the applied voltage. As illustrated, when an applied voltage is switched from a value V₂₋₁ to a value V₂₋₂, a maximum phase difference of λ₂₋₁-λ₂₋₂=3λ/4-m×/2 (equivalent to λ/4) (where m denotes a positive integer) is attained. A nematic liquid crystal exhibiting homogeneous alignment is adopted as the liquid crystal 126. Alternatively, a liquid crystal exhibiting homeotropic alignment may be adopted.

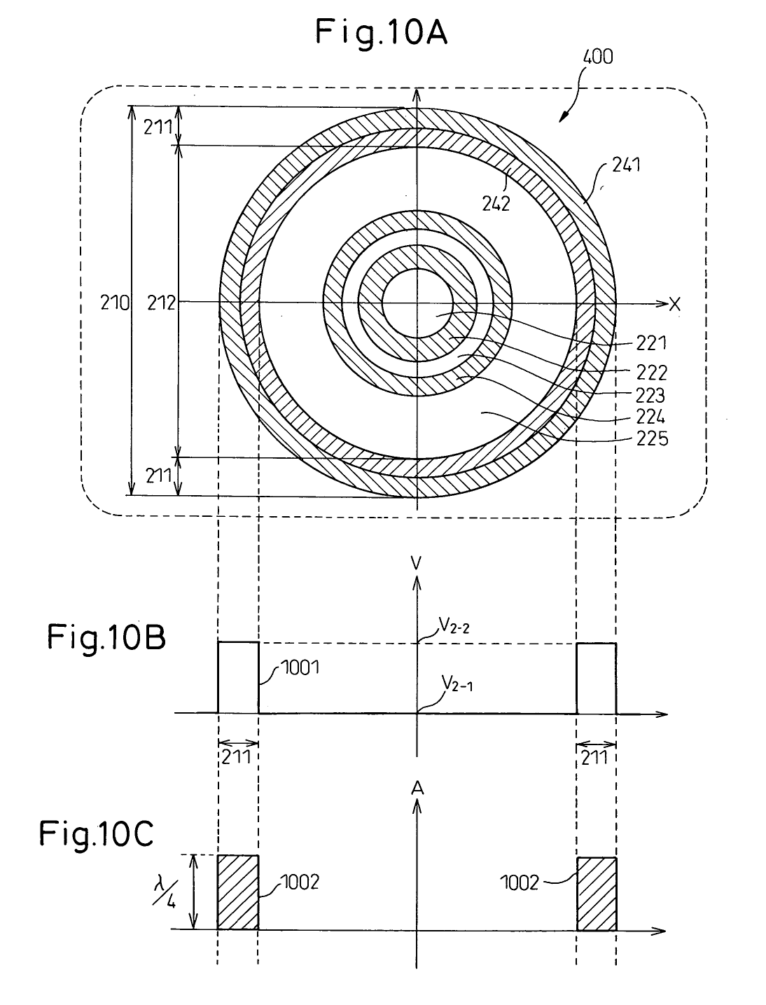

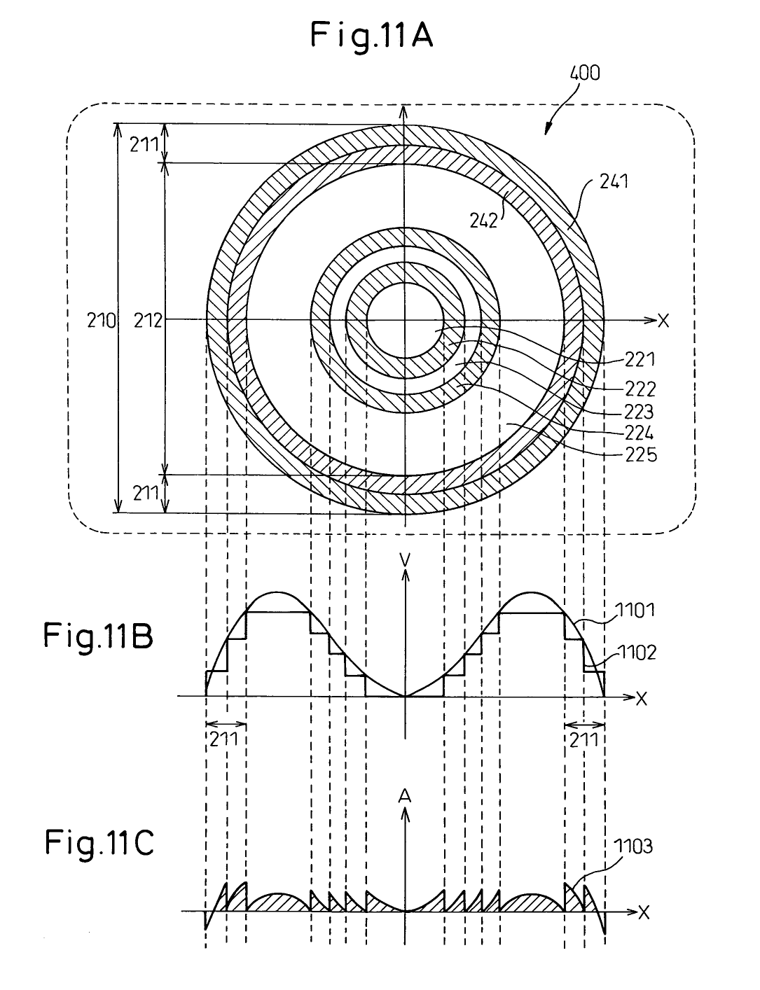

FIG. 10A shows an example of a transparent electrode pattern 400 that includes an aberration control field and an aperture control field and that can be adapted to the liquid crystal optical element 120 shown in FIG. 8.

The electrode pattern 400 includes, as shown in FIG. 10A, an aperture control field 211 defined immediately inside the perimeter of the electrode pattern 400 having a diameter 210, and an aberration compensation field 212 defined inside the aperture control field 211. Moreover, the aperture control field 211 has aperture control electrodes 241 and 242 disposed concentrically. The aberration compensation field 212 has spherical aberration compensation electrodes 221 to 225 disposed concentrically. A microscopic space is formed between adjoining ones of the aperture control electrodes 241 and 242 and between adjoining ones of the spherical aberration compensation electrodes 221 to 225 for the purpose of isolation.

FIG. 10B shows an example of a distribution of values of a voltage that is applied to the transparent electrode pattern 400 in order to cause incident light passing through the aperture control field 211 to undergo a λ/4 aberration, that is, an aberration equivalent to a quarter of the wavelength of the light. When the voltage 1001 whose distribution is shown in FIG. 10B is applied, a potential difference (|V₂₋₁-V₂₋₂|) occurs between the transparent electrode pattern 400 and transparent opposite electrode 108. As shown in FIG. 10C, the light passing through the aperture control field 211 undergoes a maximum phase difference 1002 (equivalent to λ/4) proportional to the potential difference.

In this case, substantially identical voltages are applied to the electrodes 241 and 242 in the aperture control field 211. Moreover, an even voltage (for example, a reference voltage of 0 V) is applied to the electrodes 221 to 225 disposed in the aberration compensation field 212 for fear of light passing through the aberration compensation field undergoing aberration. Spherical aberration compensation is not performed.

FIG. 11A shows the transparent electrode pattern 400 identical to the one shown in FIG. 10A. FIG. 11B shows an example of a voltage applied to the transparent electrode pattern 400 in order to compensate for spherical aberration. FIG. 11C shows an example of compensated-for aberration (A).

A curve 1101 shown in FIG. 11B is an example of a profile representing the values of spherical aberration, which is attributable to the fact that the distance from the objective lens to the track surface is not stabilized due to irregularity in the thickness of an optically transmittable protective layer coated over the track surface of a recording medium, by converting positions in an entrance pupil formed by the objective lens. A voltage 1102 whose distribution is shown in FIG. 11B is applied to the electrodes 241 and 242 in the aperture control field 211 and the electrodes 221 to 225 in the aberration compensation field 212. Consequently, a potential difference occurs between the transparent electrode pattern and the transparent opposite electrode 108. Eventually, the orientation of the liquid crystal 126 interposed between the transparent electrode pattern and the transparent opposite electrode changes proportionally to the potential difference. A light beam passing through the liquid crystal have an effect so that the phases of the light beam delays proportionally to the potential difference. Consequently, spherical aberration 1101 is restricted to residual aberration 1103, which results from aberration compensation as shown in FIG. 11C, according to the phase delay proportional to the potential difference. As shown in FIG. 11B, when any other voltage is applied to the electrodes 241 and 242 in the aperture control field 211, the spherical aberration can be compensated for more accurately.

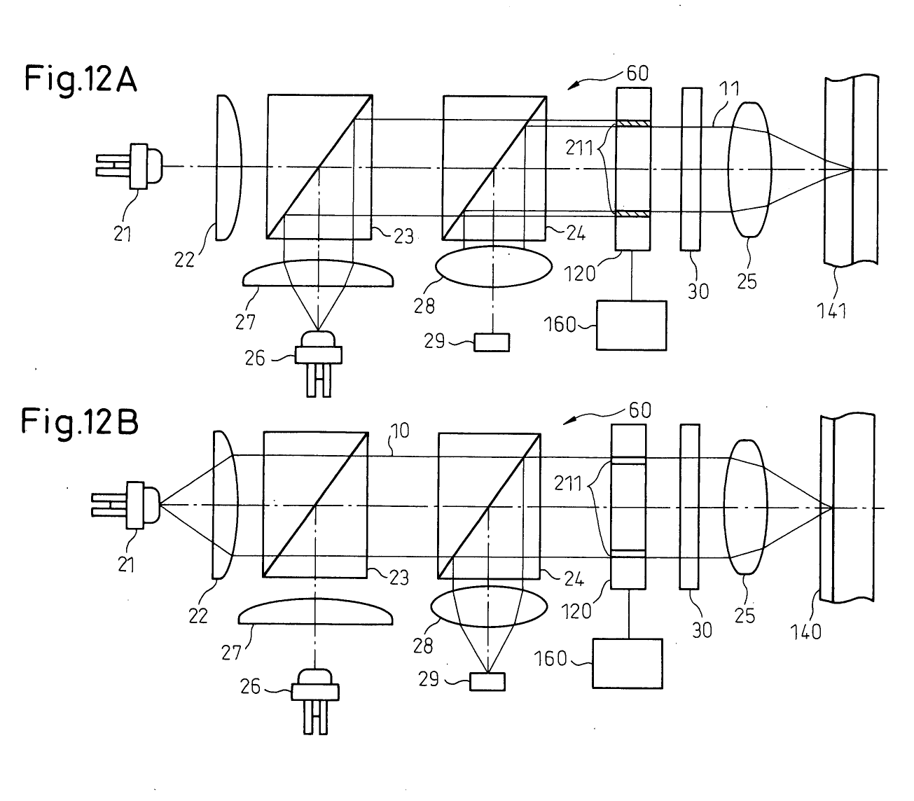

FIG. 12 shows an example of the outline configuration of an optical device 60 employing the liquid crystal optical element 120 that includes the transparent electrode pattern 400.

As shown in FIG. 12, the optical device 60 includes a first light source 21, a first collimator lens 22, a second light source 26, a second collimator lens 27, a half mirror 23, a polarization beam splitter 24, a liquid crystal optical element 120 including an aperture control field 211, a drive control circuit 160 for the liquid crystal optical element 120, an objective lens 25, a condenser lens 28, a light receiver 29, and a quarter-wave plate 30.

The diameter of the transparent electrode pattern 400 defined by the perimeter of the aperture control field 211 is coincident with an effective diameter 10 (φ=3 mm) attained when the first light source 21 is employed. The diameter of the aberration compensation field 212 is coincident with an effective diameter 11 (φ=2.35 mm) attained when the second light source 26 is employed.

FIG. 12A shows a case where the second light source 21 is lit and the second recording medium 141 such as a CD is employed. In this case, the drive control circuit 160 extends control so that the voltage 1001 whose distribution is shown in FIG. 10B is applied to the transparent electrode pattern 400. Consequently, a maximum phase difference 1002 (equivalent to λ/4) shown in FIG. 10C occurs in the portions of the liquid crystal corresponding to the electrodes 241 and 242. A light beam to be focused on the second recording medium 141 fails to converge on an exact imaging point. In other words, light passing through the aperture control field 211 is allowed to diverge, but is substantially not focused by the objective lens 25.

A second light beam (780 nm) emanating from the second light source 26 is converted into nearly parallel-ray light by the second collimator lens 27, and has the path thereof changed by the half mirror 23. The light beam then passes through the polarization beam splitter 24 and falls on the liquid crystal optical element 120. In this case, light passing through the aperture control field 211 diverges.

In contrast, light passing through the aberration compensation field 212 is not affected as mentioned above, but passes through the liquid crystal optical element 120 and falls on the quarter-wave plate 30. Light passing through the aperture control field 211 in the liquid crystal optical element 120 diverges, but is substantially not focused by the object lens 25. A light beam whose diameter corresponds to the effective diameter 11 and which has passed through the quarter-wave plate 30 is focused on the track surface of the second recording medium 141 by the objective lens 25 (in this case, the numerical aperture NA is 0.51).

A light beam reflected from the second recording medium 141 passes through each of the objective lens 25, quarter-wave plate 30, and liquid crystal optical element 120, and has the path thereof changed by the polarization beam splitter 24. The light beam is then converged on the light receiver 29 by the condenser lens 28. When the light beam is reflected from the second recording medium 141, the amplitude of the light beam is modulated by information (pits) recorded in the track surface of the second recording medium 141. The light receiver 29 transmits a light intensity signal proportional to the modulated amplitude of the received light beam. The information recorded in the second recording medium 141 is acquired from the light intensity signal (RF signal).

FIG. 12B shows a case where the first light source 21 is lit and the first recording medium 140 such as a DVD is employed. In this case, the drive control circuit 160 extends control so that the voltage whose distribution is shown in FIG. 11B is applied to the transparent electrode pattern 400. Consequently, the maximum phase difference 1002 shown in FIG. 10C (equivalent to λ/4) does not occur in the portion of the liquid crystal corresponding to the aperture control field 211. Light passing through the aperture control field 211 is not allowed to diverge. In other words, the objective lens 25 can entirely utilize light passing through both the aperture control field 211 and aberration compensation field 212. The liquid crystal optical element 120 can use the aperture control field 211 and aberration compensation field 212 to achieve aberration compensation.

Consequently, the first light beam (650 nm) emanating from the first light source 21 is converted into nearly parallel-ray light by the first collimator lens 22. The first light beam then passes through each of the half mirror 23, polarization beam splitter 24, and liquid crystal optical element 120, and then falls on the quarter-wave plate 30. A light beam whose diameter corresponds to the effective diameter 10 and which has passed through the quarter-wave plate 30 is focused on the track surface of the first recording medium 140 by the objective lens 25 (in this case, the numerical aperture NA is 0.65).

A light beam reflected from the first recording medium 140 passes through the objective lens 25 and has the path thereof changed by the polarization beam splitter 24. The light beam is then converged on the light receiver 29 by the condenser lens 28. When the light beam is reflected from the first recording medium 140, the amplitude thereof is modulated by information (pits) recorded in the track surface of the first recording medium 140. The light receiver 29 transmits a light intensity signal proportional to the modulated amplitude of the received light beam. The information recorded in the first recording medium is acquired from the light intensity signal (RF signal).

As mentioned above, when the voltage 1001 whose distribution is shown in FIG. 10B is applied to the transparent electrode pattern 400 in the liquid crystal optical element 120 included in the optical device 60, light passing through the aperture control field 211 diverges and only light passing through the aberration compensation field 212 can be utilized (see FIG. 12A). Moreover, when the voltage 1102 whose distribution is shown in FIG. 11B is applied to the transparent electrode pattern 400, light passing through the aperture control field 211 and aberration compensation field 212 can be utilized, and the light passing through the aperture control field 211 and aberration compensation field 212 can be compensated for aberration (see FIG. 12B). In short, one liquid crystal optical element can achieve both aperture control and aberration compensation so as to be compatible with a plurality of types of recording media (DVD and CD).

When the liquid crystal optical element 120 uses the aperture control field 211 and aberration compensation field 212 to achieve spherical aberration compensation, spherical aberration deriving from inconsistency of the center of the diameter of a light beam with the center of an objective lens caused by erroneous tracking or attachment can be compensated for appropriately (see FIG. 11C).

In the present embodiment, the liquid crystal optical element 120 is interposed between the polarization beam splitter 24 and quarter-wave plate 30. Alternatively, the liquid crystal optical element may be interposed between the polarization beam splitter 24 and half mirror 23.

In the present embodiment, the transparent electrode pattern 400 including, as shown in FIG. 10A and FIG. 11A, the aperture control field 211 and spherical aberration compensation field 212 has been described. However, coma can be compensated for instead of spherical aberration. In this case, coma compensation electrodes 231 to 235 (see FIG. 7) should be disposed in the aberration compensation field 212 in the transparent electrode pattern 400 in place of the spherical aberration compensation electrodes 221 to 225.

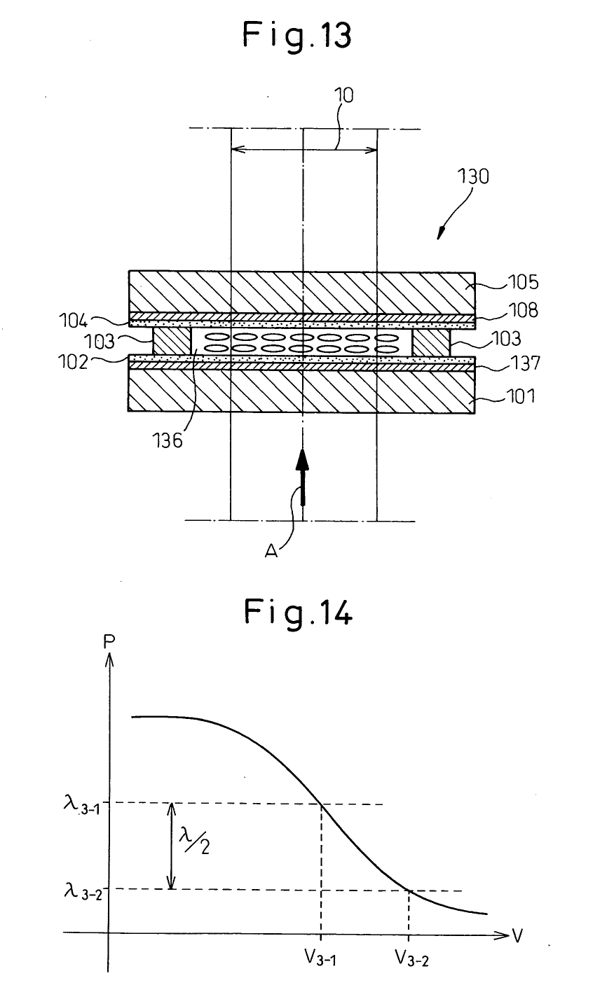

FIG. 13 shows a cross section of a liquid crystal optical element 130 in accordance with the third embodiment of the present invention.

The liquid crystal optical element 130 in accordance with the third embodiment includes an aperture control field and an aberration compensation field, induces a phase diffraction pattern in the aperture control field, and restricts an aperture by utilizing divergence of light derived from diffraction.

In FIG. 13, a direction indicated by an arrow A is a direction in which light travels to fall on the liquid crystal optical element 130. In FIG. 13, the same reference numerals are assigned to components identical to those shown in FIG. 1. A marked difference between the liquid crystal optical element 100 shown in FIG. 1 and the liquid crystal optical element 130 shown in FIG. 13 lies in a point that the liquid crystal optical element shown in FIG. 13 has a transparent electrode pattern 500 which induces divergence of light through diffraction.

FIG. 14 shows a graph indicating the relationship between a voltage (V) applied to the liquid crystal 136 employed in the present embodiment and a phase (P).

As shown in FIG. 14, the liquid crystal 136 exhibits a nonlinear characteristic such that a phase gradually decreases along with a rise in an applied voltage. As illustrated, when the applied voltage is changed from a value V₃₋₁ to a value V₃₋₂, a phase difference of λ₃₋₁-λ₃₋₂=λ/2 takes place. A nematic liquid crystal exhibiting homogeneous alignment is adopted as the liquid crystal 126. Alternatively, a liquid crystal exhibiting homeotropic alignment may be adopted.

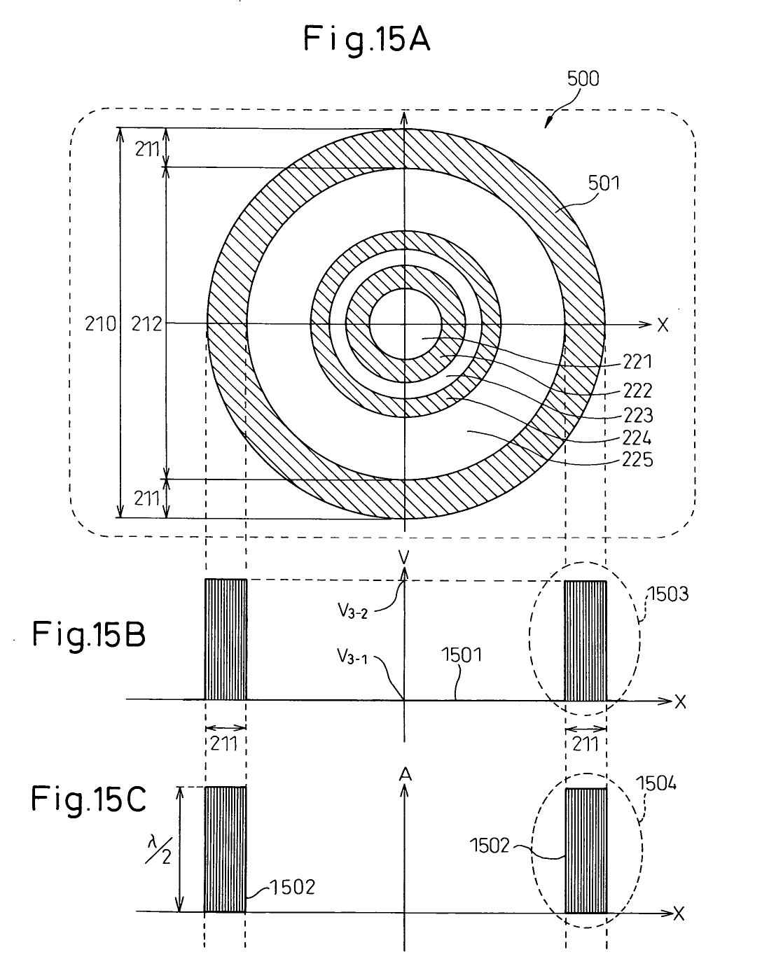

FIG. 15A shows an example of a transparent electrode pattern 500 that includes an aberration compensation field and an aperture control field and that can be adapted to the liquid crystal optical element 130 shown in FIG. 13.

The electrode pattern 500 includes, as shown in FIG. 15A, an aperture control field 211 defined inside the perimeter of the electrode pattern 500 having a diameter 210, and an aberration compensation field 212 defined inside the aperture control field 211. Moreover, a plurality of annular electrodes 501 designed for aperture control is disposed in the aperture control field 211. Furthermore, electrodes 221 to 225 designed for spherical aberration compensation are disposed concentrically in the aberration compensation field 212. A microscopic space is formed between adjoining ones of the aperture control electrodes 501 and the spherical aberration compensation electrodes 221 to 225 for the purpose of isolation.

FIG. 15B shows an example of a distribution of values of a voltage that is applied to the transparent electrode pattern 500 in order to induce a phase diffraction pattern in the aperture control field 211. When the voltage 1501 whose distribution is shown in FIG. 15B is applied, a potential difference (|V₃₋₁-V₃₋₂|) occurs between the transparent electrode pattern 500 and transparent opposite electrode 108. Consequently, a phase diffraction pattern is induced in the aperture control field 211 so that light passing through the aperture control field 211 will undergo a phase difference 1502 (equivalent to λ/2) proportional to the potential difference.

In this case, substantially the same voltage is applied to the plurality of annular electrodes 501 in the aperture control field 211. Moreover, an even voltage (for example, a reference voltage of 0 V) is applied to the electrodes 221 to 225 disposed in the aberration compensation field 212 for fear of aberration occurring. Compensation of a spherical aberration is not performed.

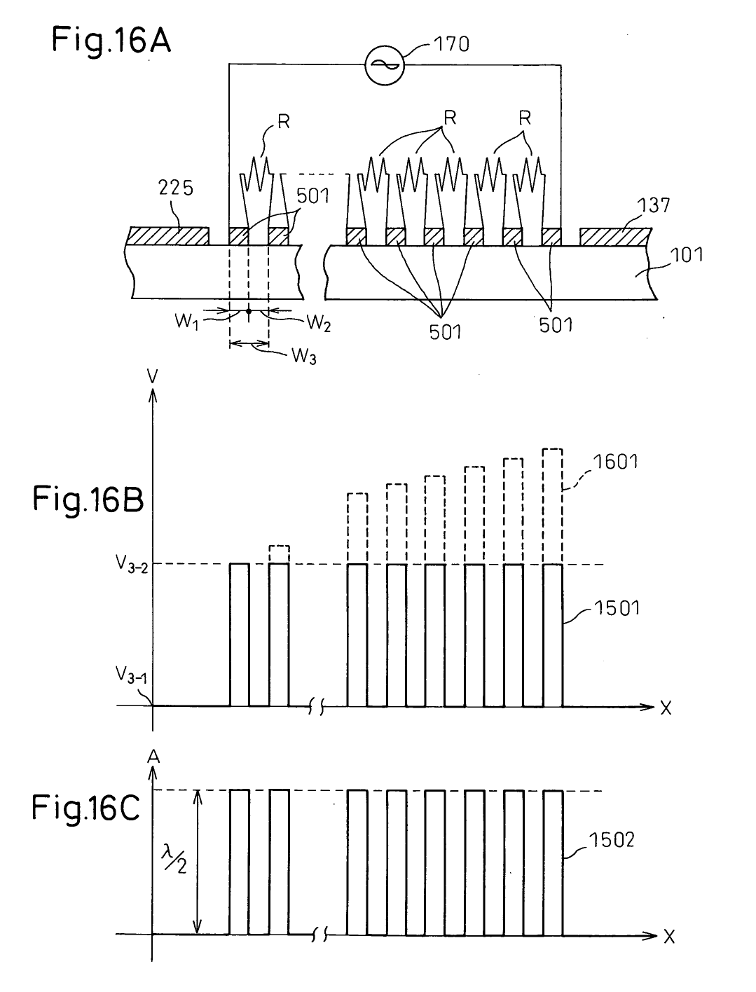

FIG. 16 shows a distribution of values of a voltage applied to the aperture control field and a distribution of values of a phase.

FIG. 16A shows in enlargement part of the aperture control field 211 shown in FIG. 15A. The plurality of annular electrodes 501 includes twenty electrodes having the same width W₁ (25 μm), the same interspace W₂ (25 μm), and the same pitch W₃ (50 μm). The width, interspace, and pitch of the annular electrodes and the number of annular electrodes are provided as an example, but the present invention will not be limited to the numerical values. The same resistor R is connected between adjoining ones of the electrodes, and the drive control circuit 170 controls the electrodes so that the potentials at adjoining electrodes will be set to a predetermined potential.

FIG. 16B shows in enlargement part of the applied-voltage distribution 1503 shown in FIG. 15B. FIG. 16B shows an effective value with respect to the voltage value V₃₋₁ (reference voltage of, for example, 0 V). Consequently, as shown in FIG. 16B, the plurality of annular electrodes 501 is retained at the voltage value V₃₋₂. Moreover, an even voltage (for example, the reference voltage of 0 V) is applied to the electrodes 221 to 225 disposed in the aberration compensation field 212 for fear of aberration occurring. Compensation for spherical aberration is not performed.

FIG. 16C shows in enlargement part of the aberration 1504 shown in FIG. 15C. FIG. 16C shows an example of a phase diffraction pattern induced by applying a predetermined voltage to the electrodes 501. A phase difference caused by each electrode is preferably set to λ/2, that is, a half of the wavelength of light. Once the phase diffraction pattern shown in FIG. 16C is induced by applying the predetermined voltage to the electrodes 501, the phase diffraction pattern optically serves as a so-called Ronchi grating. Light passing through the aperture control field 211 is diffracted to diverge.

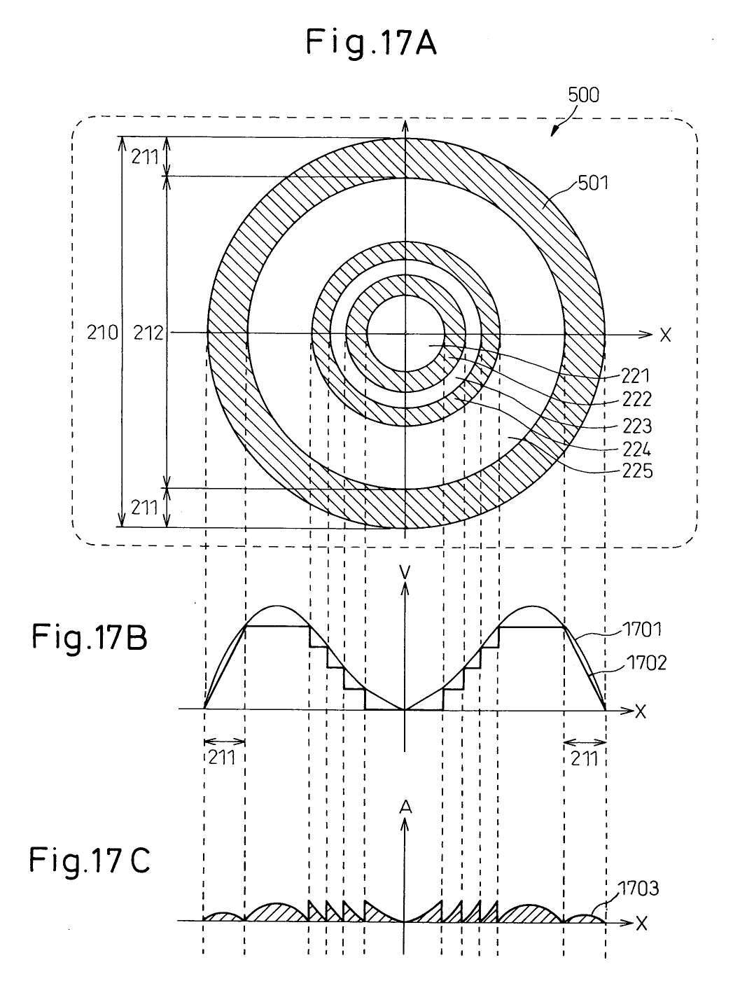

FIG. 17A shows the same transparent electrode pattern 500 as the one shown in FIG. 15A. FIG. 17B shows an example of a distribution of values of a voltage applied to the transparent electrode pattern 500. FIG. 17C shows an example of compensated-for aberration (A).

A curve 1701 shown in FIG. 17B is an example of a profile representing the values of a spherical aberration, which is attributable to the fact that the distance from an objective lens to a track surface is not stabilized, due to irregularity in the thickness of an optically transmittable protective layer coated over the track surface of a recording medium, by converting positions in an entrance pupil formed by the objective lens. When a voltage 1702 whose distribution is shown in FIG. 17B is applied to the electrodes 501 in the aperture control field 211 and the electrodes 221 to 225 in the aberration compensation field 2-11, a potential difference occurs between the transparent electrode pattern and transparent opposite electrode 108. Consequently, the orientation of the liquid crystal 136 changes proportionally to the potential difference. A light beam passing through the liquid crystal 136 is allowed to have the phases of respective light waves thereof delayed proportionally to the potential difference. Consequently, the spherical aberration 1701 is restricted to residual aberration 1703, which results from aberration compensation and is shown in FIG. 17C, due to the phase delay proportional to the potential difference.

When the voltage 1702 whose distribution is shown in FIG. 17B is applied, a voltage 1601 indicated with a dashed line in FIG. 16B is applied to the electrodes 501 in the aperture control field 211. Specifically, the drive control circuit 170 applies the voltage so that a predetermined potential difference occurs between the innermost electrode and the outermost electrode. The application of the voltage by the drive control circuit 170 brings about resistive potential division, which is achieved by the resistors R disposed among the electrodes, whereby the potential difference is induced. Consequently, the voltage having the value thereof varied stepwise as shown in FIG. 16B is applied to each of the electrodes. Alternatively, the voltage having the value thereof varied as shown in FIG. 16 may not be applied, but independent voltages may be applied to the respective electrodes 501.

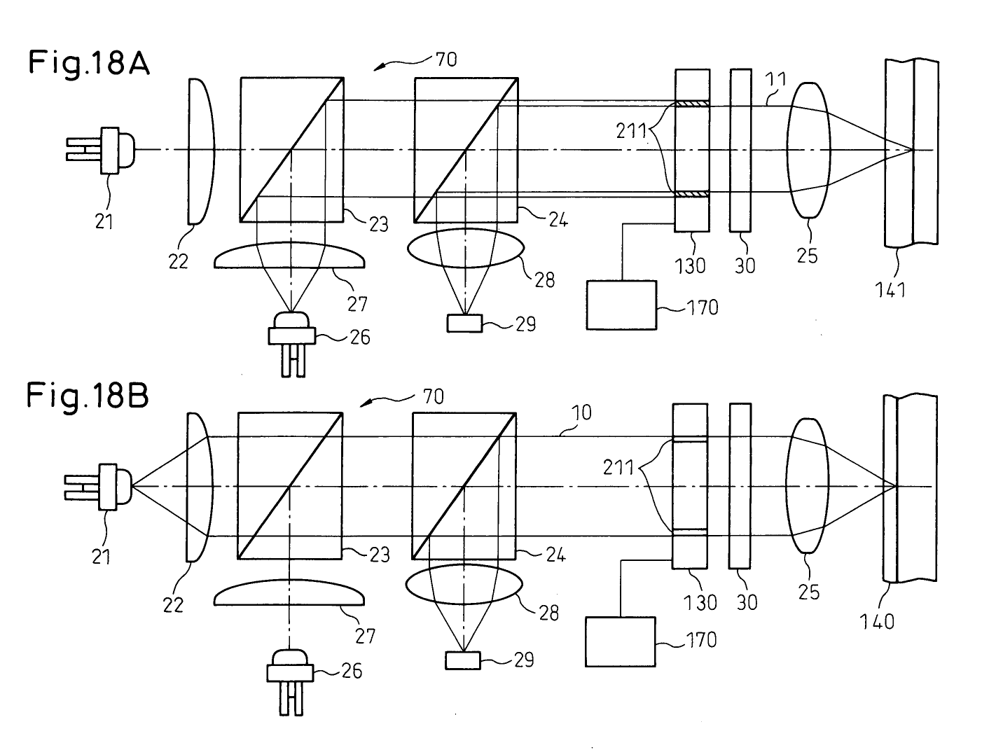

FIG. 18 shows an example of the outline configuration of an optical device 70 employing a liquid crystal optical element 130 that includes the transparent electrode pattern 500.

As shown in FIG. 18, the optical device 70 includes a first light source 21, a first collimator lens 22, a second light source 26, a second collimator lens 27, a half mirror 23, a polarization beam splitter 24, a liquid crystal optical element 130 including an aperture control field 211, a drive control circuit 170 for the liquid crystal optical element 130, an objective lens 25, a condenser lens 28, a light receiver 29, and a quarter-wave plate 30.

The diameter of the transparent electrode pattern 500 defined by the perimeter of the aperture control field 211 is coincident with an effective diameter 10 (φ=3 mm) attained when the first light source 21 is employed, and the diameter of the aberration compensation field 212 is coincident with an effective diameter 11 (φ=2.35 mm) attained when the second light source 26 is employed.

FIG. 18A shows a case where the second light source 21 is lit and the second recoding medium 141 such as a CD is employed. In this case, the drive control circuit 170 extends control so that the voltage 1501 whose distribution is shown in FIG. 15B is applied to the transparent electrode pattern 500. Consequently, a phase diffraction pattern that brings about the phase difference 1502 (equivalent to λ/2) shown in FIG. 15C is induced in the portions of the liquid crystal corresponding to the electrodes 501. Light passing through the aperture control field 211 is allowed to diverge, but is substantially not focused by the objective lens 25.

A second light beam (780 nm) emanating from the second light source 26 is converted into nearly parallel-ray light by the second collimator lens 27. The second light beam has the path thereof changed by the half mirror 23, passes through the polarization beam splitter 24, and falls on the liquid crystal optical element 130. In this case, light passing through the aperture control field 211 diverges.

In contrast, light passing through the aberration compensation field 212 is not affected as mentioned above, but passes through the liquid crystal optical element 130 and falls on the quarter-wave plate 30. Light passing through the aperture control field 211 in the liquid crystal optical element 130 diverges, but is substantially not focused by the objective lens 25. A light beam whose diameter corresponds to the effective diameter 11 and which has passed through the quarter-wave plate 30 is focused on the track surface of the second recording medium 141 by the objective lens 25 (in this case, the numerical aperture NA is 0.51).

A light beam reflected from the second recording medium 141 passes through each of the objective lens 25, quarter-wave plate 30, and liquid crystal optical element 130, and has the path thereof changed by the polarization beam splitter 24. The light beam is then converged on the light receiver 29 by the condenser lens 28. When the light beam is reflected from the second recording medium 141, the amplitude thereof is modulated by information (pits) recorded in the track surface of the second recording medium 141. The light receiver 29 transmits a light intensity signal proportional to the modulated amplitude of the received light beam. The information recorded in the second recording medium 141 can be acquired from the light intensity signal (RF signal).

FIG. 18B shows a case where the first light source 21 is lit and the first recording medium such as a DVD is employed. In this case, the drive control circuit 170 extends control so that the voltage 1702 whose distribution is shown in FIG. 17B will be applied to the transparent electrode pattern 500. Consequently, the phase diffraction pattern that brings about the phase difference 1502 (equivalent to λ/2) shown in FIG. 15C is not induced in the portion of the liquid crystal corresponding to the aperture control field 211. Light passing through the aperture control field 211 is not allowed to diverge. Namely, in this case, the objective lens 25 can entirely utilize light passing through the aperture control field 211 and aberration compensation field 212. The liquid crystal optical element 130 can use the aperture control field 211 and aberration compensation field 212 to achieve aberration compensation.

Consequently, the first light beam (650 nm) emanating from the first light source 21 is converted into nearly parallel-ray light by the first collimator lens 22. The first light beam passes through each of the half mirror 23, polarization beam splitter 24, and liquid crystal optical element 130, and falls on the quarter-wave plate 30. A light beam whose diameter corresponds to the effective diameter 10 and which has passed through the quarter-wave plate 30 is focused on the track surface of the first recording medium 140 by the objective lens 25 (in this case, the numerical aperture NA is 0.65).

A light beam reflected from the first recording medium 140 passes through the objective lens 25 and has the path thereof changed by the polarization beam splitter 24. The light beam is then converged on the light receiver 29 by the condenser lens 28. When the light beam is reflected from the first recording medium 140, the amplitude thereof is modulated by information (pits) recorded in the track surface of the first recording medium 140. The light receiver 29 transmits a light intensity signal proportional to the modulated amplitude of the received light beam. The information recorded in the first recording medium can be acquired from the light intensity signal (RF signal).

As mentioned above, the voltage 1501 whose distribution is shown in FIG. 15B is applied to the transparent electrode pattern 500 in the liquid crystal optical element 130 included in the optical device 70, whereby light passing through the aperture control field 211 diverges. Only light passing through the aberration compensation field 212 can be utilized (see FIG. 18A). Moreover, when the voltage 1702 whose distribution is shown in FIG. 17B is applied to the transparent electrode pattern 500, light passing through the aperture control field 211 and aberration compensation field 212 can be utilized, and the light passing through the aperture control field 211 and aberration compensation field 212 can be compensated for aberration (see FIG. 18B). In short, one liquid crystal optical element can be used to achieve both aperture control and aberration compensation so as to be compatible with a plurality of types of recording media (DVD and CD).

The present embodiment has been described on the assumption that the transparent electrode pattern 500 includes, as shown in FIG. 15A and FIG. 17A, the aperture control field 211 and spherical aberration compensation field 212. Alternatively, coma can be compensated for instead of a spherical aberration. In this case, the electrodes 231 to 235 (see FIG. 7) designed for coma compensation should be disposed in the aberration compensation field 212 included in the transparent electrode pattern 500 in place of the spherical aberration compensation electrodes 221 to 225.

What is claimed is:

1. A liquid crystal optical element for controlling an aperture through which incident light passes, comprising:
a first substrate;
a second substrate;
a liquid crystal provided between the first and second substrates;
an electrode pattern formed on one of the first and second substrates and having an aperture control field and an aberration compensation field;
an aperture control electrode disposed in the aperture control field;
an aberration compensation electrode disposed in the aberration compensation field; and
an opposite electrode, which is formed on the other one of the first and second substrates, for applying a voltage between the electrode pattern and itself.

2. The liquid crystal optical element according to claim 1, wherein the aperture control electrode is used to perform both aperture control and aberration compensation.

3. The liquid crystal optical element according to claim 2, wherein the aperture control electrode includes a plurality of electrodes, and the plurality of electrodes are driven under substantially the same condition for the purpose of aperture control and are driven under different conditions for the purpose of aberration compensation.

4. The liquid crystal optical element according to claim 2, wherein the aperture control electrode change the refractive index of the liquid crystal so as to allow incident light passing through the aperture control field to diverge.

5. The liquid crystal optical element according to claim 4, wherein the aperture control electrode includes a plurality of electrodes and a refractive-index distribution induced by the plurality of electrodes is used to directly modulate incident light passing through the aperture control field so that the incident light passing through the aperture control field diverges.

6. The liquid crystal optical element according to claim 2, wherein the aperture control electrode induces an aberration in the portions of the liquid crystal corresponding to the position of the aperture control electrode so as to allow the incident light passing through the aperture control field to diverge.

7. The liquid crystal optical element according to claim 6, wherein the aperture control electrode induces an aberration equivalent to approximately a quarter of the wavelength of incident light.

8. The liquid crystal optical element according to claim 2, wherein the aperture control electrode includes a plurality of electrodes and the plurality of aperture control electrodes induce a diffraction pattern, which brings about a phase difference, in the portions of the liquid crystal corresponding to the positions of the aperture control electrodes so that the incident light passing through the aperture control field diverges.

9. The liquid crystal optical element according to claim 8, wherein the diffraction pattern induced by the plurality of aperture control electrodes optically serves as a Ronchi grating.

10. The liquid crystal optical element according to claim 1, wherein the aberration compensation field is defined inside the aperture control field.

11. The liquid crystal optical element according to claim 1, wherein a plurality of coma compensation electrodes is disposed in the aberration compensation field.

12. The liquid crystal optical element according to claim 1, wherein a plurality of spherical aberration compensation electrodes is disposed concentrically in the aberration compensation field.

13. An optical device comprising:
a light source;
a liquid crystal optical element including a first substrate, a second substrate, a liquid crystal provided between the first and second substrates, an electrode pattern formed on one of the first and second substrates and having an aperture control field and an aberration compensation field, an aperture control electrode disposed in the aperture control field, an aberration compensation electrode disposed in the aberration compensation field, and an opposite electrode, which is formed on the other one of the first and second substrates, for applying a voltage between the electrode pattern and itself; and
an objective lens for focusing light passing through the liquid crystal optical element.

14. The optical device according to claim 13, wherein the liquid crystal optical element uses the aperture control field thereof to control an aperture through which incident light emanating from the light source passes, and uses the aperture control field and aberration compensation field thereof to compensate for aberration.

15. The optical device according to claim 14, further comprising a driver that drives the aperture control electrodes for the purpose of aperture control, and drives the aperture control electrode and the aberration compensation electrode for the purpose of aberration compensation.

16. The optical device according to claim 15, wherein the aperture control electrode includes a plurality of electrodes and the driver drives the plurality of electrodes under substantially the same condition for the purpose of aperture control, and drives the plurality of electrodes under different conditions for the purpose of aberration compensation.

17. An aperture control method in an optical device comprising a first light source, a second light source, a liquid crystal optical element including a first substrate, a second substrate, a liquid crystal provided between the first and second substrates, an electrode pattern formed on one of the first and second substrates and having an aperture control field and an aberration compensation field, an aperture control electrode disposed in the aperture control field, an aberration compensation electrode disposed in the aberration compensation field, and an opposite electrode, which is formed on the other one of the first and second substrates, for applying a voltage between the electrode pattern and itself, an objective lens for focusing light passing through the liquid crystal optical element, and a driver for driving the electrode pattern, the method comprising the steps of:
lighting the first light source;
driving the aperture control electrode by using the driver, and focusing light, which emanates from the first light source and passes through the aperture control field and aberration compensation field in the liquid crystal optical element, on the first recording medium by using the objective lens;
lighting the second light source; and
driving the aperture control electrode by using the driver, and focusing only light, which emanates from the second light source and passes through the aberration compensation field in the liquid crystal optical element, on the second recording medium by using the objective lens.

18. The aperture control method according to claim 17, wherein at the step of focusing light on the first recording medium, light emanating from the first light source and passing through the aberration compensation field in the liquid crystal optical element is compensated for aberration.

19. The aperture control method according to claim 18, wherein at the step of focusing light on the first recording medium, light emanating from the first light source and passing through the aperture control field in the liquid crystal optical element is compensated for aberration.

20. The aperture control method according to claim 19, wherein the aperture control electrode includes a plurality of electrodes, and at the step of focusing light on the first recording medium, the driver drives the plurality of electrodes under different conditions and at the step of focusing light on the second recording medium, the driver drives the plurality of electrodes under substantially the same condition.
